(19) United States
(12) Patent Application Publication
(10) Pub. No.: US 2005/0120290 A1
(43) Pub. Date: Jun. 2, 2005

(54) Page rendered electronic file processing

(75) Inventors: Anantkumar G. Mistry, Aurora, CO (US); Kenneth D. Weinert, Westminster, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Information Handling Services Inc., Englewood, CO (US)

(21) Appl. No.: 10/997,750

(22) Filed: Nov. 23, 2004

Related U.S. Application Data
(60) Provisional application No. 60/526,189, filed on Dec. 1, 2003.

(51) Int. Cl. G06F 15/00

(52) U.S. Cl. 715/500

(57) ABSTRACT

A method of delivering a document includes providing an electronic file that includes a page rendered version of the document, embedding at least one placeholder object into the electronic file during a first document preparation process, thereafter, populating a specific value into the at least one placeholder object during a second document preparation process, and transmitting an electronic file that includes the document to a requester.

### CROSS-REFERENCES TO RELATED APPLICATIONS

This application is a non-provisional of, and claims the benefit of, co-pending, commonly-assigned, Provisional U.S. Patent Application No. 60/526,189 (Attorney Docket No. 040050-000700) entitled “PAGE RENDERED ELECTRONIC FILE PROCESSING,” filed on Dec. 1, 2003, the entirety of which application is incorporated herein for all purposes.

This application is related to co-pending, commonly-assigned, and concurrently filed U.S. patent application Ser. No. ______ (Attorney Docket No. 040050-000810) entitled “UNREFERENCED OBJECT IN PAGE RENDERED ELECTRONIC FILE,” which is a non-provisional of, and claims the benefit of, co-pending, commonly-assigned, Provisional U.S. Patent Application No. 60/526,184 (Attorney Docket No. 040050-000800) entitled “UNREFERENCED OBJECT IN PAGE RENDERED ELECTRONIC FILE,” filed on Dec. 1, 2003, and is related to co-pending, commonly-assigned U.S. patent application Ser. No. 10/977,541 (Attorney Docket No. 040050-000610) entitled “REMOTE ACCESS PRINTING SYSTEMS AND METHODS,” which is a non-provisional of, and claims the benefit of, co-pending, commonly-assigned, Provisional U.S. Patent Application No. 60/516,001 (Attorney Docket No. 040050-000600) entitled “REMOTE ACCESS PRINTING,” filed on Oct. 31, 2003, the entirety of each of which applications are incorporated herein for all purposes.

### BACKGROUND OF THE INVENTION

Embodiments of the present invention relate generally to document protection systems and methods. More specifically, embodiments of the present invention related to systems and methods for embedding document protection features into page rendered electronic documents.

Many copyrighted documents are distributed in a controlled manner. This can be done in either hard or softcopy. Hard copies, such as a book, are easy to control the copyright as users typically know reproduction of the book is protected. In the case of standards, specifications, and technical publications, they are often printed and mailed for those users wanting a hardcopy. Still, many users ignore copyright and license information printed on the hardcopies and reproduce the documents in violation of the document owner's copyright.

Further, in addition to similar issues with respect to softcopies of copyrighted documents, there exists apparent user confusion as well. Soft copies are delivered in digital form, which makes perfect copies easy to produce. Some users have the misconception that soft copies can be disseminated more loosely. Most copyright holders would disagree.

Thus, systems and methods are needed that deter certain activities with respect to copyrighted documents, both hardcopies and softcopies.

### BRIEF SUMMARY OF THE INVENTION

Embodiments of the present invention thus provide a method of delivering a document. The method includes providing an electronic file that includes a page rendered version of the document, embedding at least one placeholder object into the electronic file during a first document preparation process, thereafter, populating a specific value into the at least one placeholder object during a second document preparation process, and transmitting an electronic file that includes the document to a requester.

Providing an electronic file that includes a page rendered version of the document may include providing an electronic file in Portable Document Format. Providing an electronic file that includes a page rendered version of the document may include scanning a hard copy of the document to create the page rendered version of the document. Providing an electronic file that includes a page rendered version of the document may include converting an electronic file that includes a non-page rendered version of the document to the page rendered version of the document. Embedding at least one placeholder object into the electronic file may include embedding an unreferenced placeholder object into the electronic file. Embedding at least one placeholder object into the electronic file may include embedding a referenced placeholder object into the file. Embedding a referenced placeholder object into the file may include embedding a fixed location placeholder object into the file. Embedding a referenced placeholder object into the file may include embedding a variable location placeholder object into the file. Populating a specific value into the at least one placeholder object may include populating copyright information into a fixed location placeholder object. Populating a specific value into the at least one placeholder object may include populating license information into a fixed location placeholder object. Populating a specific value into the at least one placeholder object may include populating an encoded image into a variable location placeholder object. Transmitting an electronic file that includes the document to the requestor may include emailing the document. Transmitting an electronic file that includes the document to the requestor may include mailing a computer-readable medium that includes the document. Transmitting an electronic file that includes the document to the requestor may include storing the document on a server for downloading by the requester.

Other embodiments provide a document delivery system that includes a storage arrangement, a processor, and a computer-readable medium having stored thereon computer-executable instructions that program the processor. The instructions program the processor to receive an electronic file that includes a page rendered version of a document, embed at least one placeholder object into the electronic file during a first document preparation process, store the electronic file that includes the embedded placeholder object at the storage arrangement for further processing, populate a specific value into the at least one placeholder object during a second document preparation process, and transmit the electronic file that includes the document to a requestor. The instructions may program the processor to receive an electronic file in Portable Document Format. The instructions may program the processor to embed a variable location placeholder object into the file. The object may be an XObject associated with Portable Document Format.

Still other embodiment provide a document delivery system. The system includes means for storing electronic files, means for embedding a placeholder object into an electronic file that includes a page rendered version of a document, means for populating a specific value into the at least one placeholder object, and means for transmitting the electronic file that includes the document to a requestor.

Further embodiment provide a computer-readable medium having stored thereon instructions for programming a processor to receive an electronic file comprising a page rendered version of a document, instructions for programming the processor to embed at least one placeholder object into the electronic file, instructions for programming the processor to store the electronic file comprising the embedded placeholder object for further processing, instructions for programming the processor to populate a specific value into the at least one placeholder object, and instructions for programming the processor to transmit the electronic file that includes the document to a requestor. The instructions may include instructions for programming the processor to receive the electronic file in Portable Document Format.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a document delivery system according to embodiments of the invention.

FIGS. 2A-C illustrate methods of embedding document protection featured into a page-rendered electronic document.

FIG. 3 illustrates a page-rendered electronic document having placeholder objects embedded therein.

### DETAILED DESCRIPTION OF THE INVENTION

Embodiments of the present invention provide document protection systems and methods. In some embodiments, objects are embedded into page-rendered electronic versions of copyrighted documents.

Objects may be referenced, such that one or more objects produce visible output in a rendered version of the document, either electronic (e.g., on a display device) or hardcopy (e.g., on a paper hardcopy). Objects may be unreferenced, such that the object exists only in the electronic version of the document.

Referenced objects may be fixed or variable. Fixed objects appear in a specific location on one or more pages of the document. Variable objects may appear in a different location on different document pages.

Objects may produce specific text or images, such as copyright and/or license information. In some embodiments, objects produce encoded tags that provide information such as a session identification, in which the document was ordered.

In some embodiments, placeholder objects are embedded in a pre-stamp process and populated in a post-stamp process. Embedding objects in a pre-stamp process may allow the placeholder objects to be populated in the post-stamp process without having to re-linearize the document. Hence, documents can be customized for a specific order yet delivered in near real time.

In some embodiments, the page-rendered electronic version of the document is in Portable Document Format (PDF). The objects may be XObjects associated with PDF.

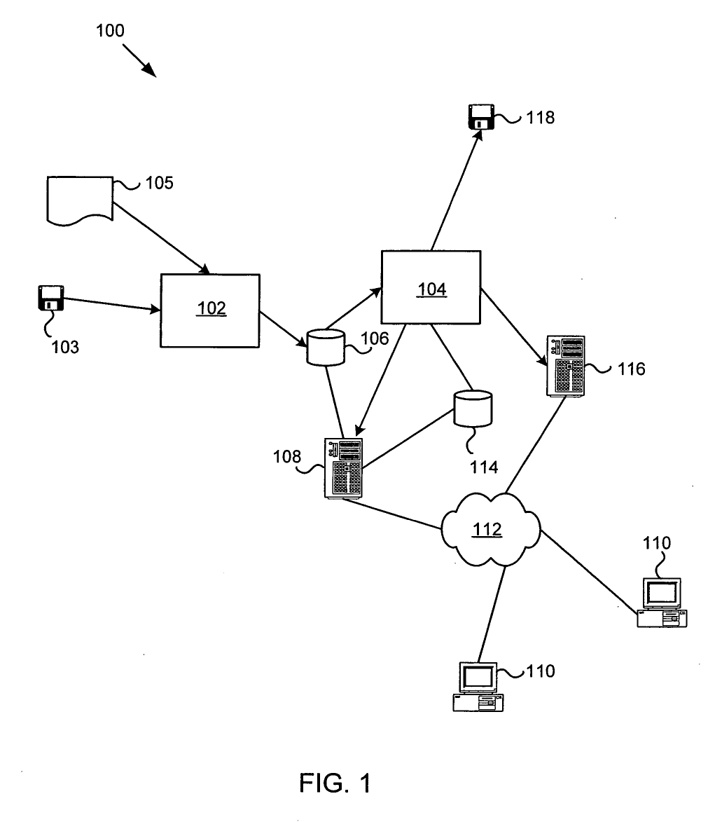

Having described embodiment of the present invention generally, attention is directed to FIG. 1, which illustrates an exemplary system 100 for producing documents according to embodiments of the invention. Those skilled in the art will appreciate that the system 100 is merely exemplary of a number of possible system embodiments according to the invention. Using the system 100, page-rendered documents may be produced and distributed using a bifurcated production process.

The system 100 includes a pre-stamp process 102, as will be described in more detail hereinafter. The pre-stamp process 102 may be implemented in hardware, software, firmware, or the like. In a specific embodiment, the pre-stamp process 102 comprises a software application (i.e., computer-executable instructions) stored on a computer-readable medium, which application may operate on any of the computing devices to be described below. The pre-stamp process 102 receives electronic files 103 comprising page-rendered documents made up of objects, and outputs electronic files comprising page-rendered documents made up of objects. The output files, however, may have additional objects embedded therein. The additional objects comprise placeholder objects into which specific variables may be populated in a post-stamp process 104 without having to re-linearize or re-optimize the file. In some embodiments, the pre-stamp process receives paper documents 105 and produces electronic files comprising the documents in page-rendered form.

The input files and output files may be in any of a variety of page-rendered formats. For example, the input and output files may be in the well-known PDF. It will be understood, however, that the term “page rendered” will be used herein to refer to any electronic file format capable of rendering a document, either electronically (e.g., via a display device) or physically (e.g., via a printer), that replicates a source document with respect to the content that appears on one or more pages of the document.

In some embodiments, the document content in a page-rendered file is made up of “objects.” Objects may be images, text, graphics, and/or the like. An object typically is associated with one or more addresses that locate the object on one or more pages of the document.

The system 100 also includes a database 106 that stores electronic files comprising pre-stamped documents. The database 106 may be any of a variety of storage arrangements, including magnetic, optical, solid state, and the like.

The system 100 also includes a web server 108 through which customers may place orders for documents. Customers may place orders using computing devices 110 communicating with the web server 108 via a network 112. The web server 108 and computing devices 110 may be any of a variety of computing devices such as a personal computers, laptop computers, desktop computers, personal digital assistants (PDAs), or the like. The network 112 may be the Internet, an intranet, a wide area network (WAN), a local area network (LAN), a virtual private network, any combination of the foregoing, or the like. The network 112 may include both wired and wireless connections, including optical links. In some embodiments, customers establish accounts and account information is stored on a customer information database 114. The database 114 may be any storage device or combination of storage devices, including solid state memory, such as RAM, ROM, PROM, and the like, magnetic memory, such as disc drives, tape storage, and the like, and/or optical memory, such as DVD.

The system 100 also includes a File Transfer Protocol (FTP) server 116 and a mailing process 118. The FTP server 116 provides a portal through which customers may download or view documents following the post-stamp process 104. The FTP server 116 may be any of the aforementioned computing devices. The mailing process 118 produces computer-readable media (e.g., CDs, DVDs, floppy disks, and/or the like) on which electronic files comprising post-stamped documents are stored. The computer-readable media then may be mailed to customers in response to orders.

The post-stamp process 104 includes receiving pre-stamped documents from the database 106 and populating one or more of the placeholder objects with specific variables, as will be described in more detail hereinafter. The post-stamp process 104 may be implemented in hardware, software, firmware, or the like. In a specific embodiment, the post-stamp process 104 comprises the same software application as the pre-stamp process 102. The specific variables populated into the placeholder objects may include customer-specific information from the customer information database 114, session-specific information from the web server 108 or the FTP server 116, copyright owner-specific information, and/or the like. In some embodiments, the post-stamp process 104 delivers documents in real time with little or no delays.

Those skilled in the art will appreciate that the various systems components illustrated and described here as individual components may be comprised by a single computing device. For example, a mainframe computer having appropriate processing and storage capacity may implement the functions of the pre-stamp process 102, the database 106, the post-stamp process 104, the web server 108, the FTP server 116, and/or the customer information database 114, in any combination. Conversely, the various components of the system 100 may be distributed across a vast geographic area and connected through a network. Many other embodiments are possible and apparent to those skilled in the art in light of this disclosure.

The system 100, may be used to implement one or more methods to be described hereinafter. Briefly, in a specific embodiment, copyrighted documents (105, 103) are received from copyright owners who enlist the services of the system operator to distribute the documents. The system operator pre-stamps the documents (102) so that the documents may be efficiently customized per order and delivered to customers. Available documents may be electronically cataloged so that a customer may use the web server 108 to locate and order them. Customers may place orders via the Internet or other network, through call centers, via mail, and/or the like. In response to an order, the system operator post-stamps the document (104) and delivers it to the customer according to the customer's directions. Documents may be delivered through the mail, via the FTP server 116, via email, via the web server 108, and/or the like.

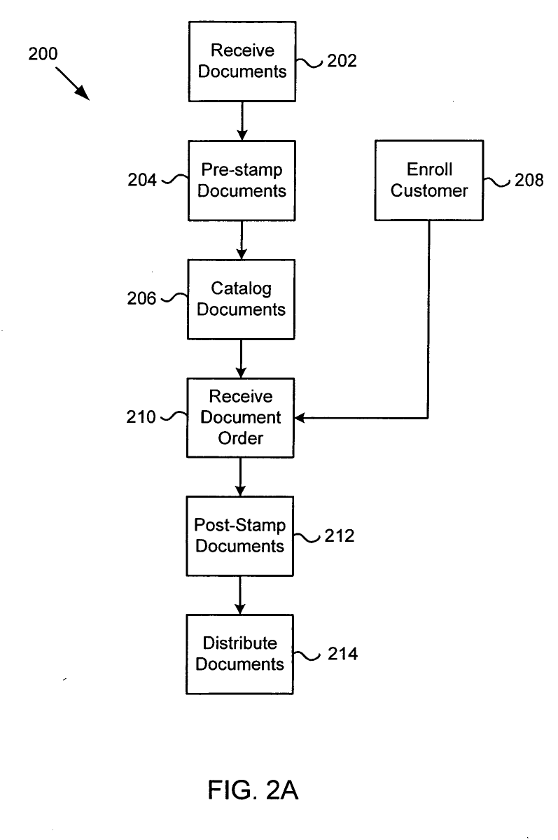

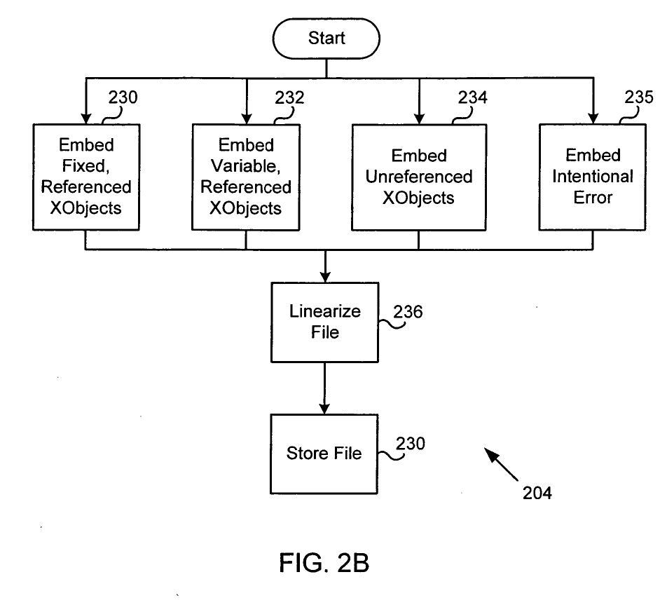

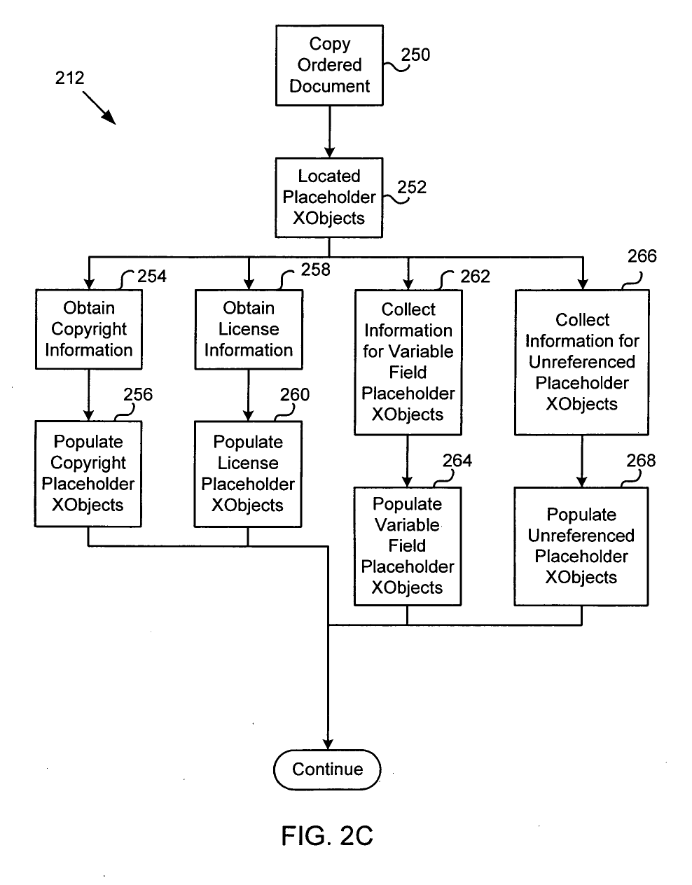

Having described an exemplary system 100 according to embodiments of the invention, attention is directed to FIG. 2A, which illustrates an exemplary method 200 according to some embodiments, which method may be implemented in the system 100 of FIG. 1. Those skilled in the art will appreciate that the method 200 is merely exemplary of a number of possible method embodiments according to the invention. Other exemplary methods may include more, fewer, or different blocks than those illustrated and described herein. Further, method blocks in other embodiments need not be traversed in the orders illustrated and described herein.

The method 200 includes receiving documents at block 202. Documents may be received as electronic files, paper documents, or the like. If electronic files, the electronic files may be in any of a variety of file types, including, for example, .pdf, .doc, .txt, .jpg, .tif, .gif, non-extension file types, and/or the like. Paper documents may be scanned or otherwise reproduced electronically so as to create an electronic file.

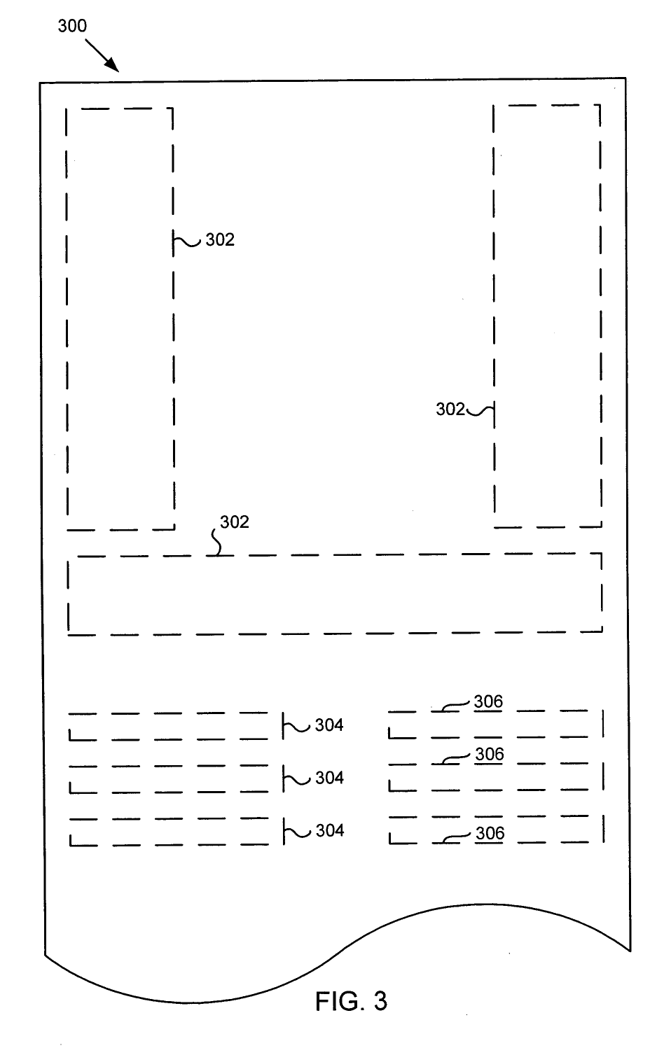

At block 204, the documents are pre-stamped. The pre-stamp process includes receiving an electronic file (which may be any of the aforementioned file types) and producing an electronic file comprising a page-rendered version of the document in which placeholder objects are embedded. The placeholder objects may be referenced or unreferenced, which means that, once populated in the post-stamp process, the objects may or may not produce user-viewable content in a document rendered using the post-stamped file. A specific example of a document rendering 300 is illustrated in FIG. 3.

FIG. 3 illustrates a document rendering 300 according to embodiments of the invention. The document rendering 300 may be produced, for example, from an electronic file comprising a document and placeholder objects. The document rendering 300 may be rendered electronically (e.g., displayed on a display device) or physically (e.g., printed using a printing device). For ease of illustration, the original document content is not pictured. The document rendering 300 includes a number of placeholder objects 302, 304, 306, illustrated as dotted line regions, which may or may not be viewable. The placeholder objects 302, 304, 306 in this illustration are not populated with specific variables.

The placeholder objects 302 represent “variable field” placeholder objects. A specific value (image, text, and/or the like) populated into one or more variable field placeholder objects may be located, in a final document, anywhere within the dotted line regions, and may be located in a different location on each page of the document. The regions represented by the placeholder objects 302 may include text or other original document content such that the specific variable overwrites the content, thus making it difficult to mask in derivative versions of the document. In a specific embodiment, the specific value populated into the variable field placeholder objects 302, which may act as a single region, comprises a bar code or similar encoding image into which useful information is embedded, as will be described in more detail hereinafter. The bar code may be the same on each page of the document, although it may “float” within the region or regions defined by the placeholder objects 302.

The placeholder objects 304, 306, shown here in a footer region, may be located anywhere on the page or pages of the document. A placeholder object such as placeholder objects 304, 306 may be configured to appear on only one page of the document, all pages of the document, random pages of the document, or specific pages of the document. In a specific embodiment, the placeholder objects 304 receive specific variables identifying copyright information during the post-stamp process, and the placeholder objects 306 receive specific variables identifying license information during the post-stamp process.

Returning to FIG. 2A and the method 200, pre-stamped documents are made available for customer orders at block 206. This may include cataloging the documents, either electronically or otherwise, so that a customer may identify a desired document and place an order for it. Thus, in some embodiments, this includes creating a document list or catalog on the web server 108 that customers may access via the Internet.

At block 208, a customer enrolls or registers to order documents with the system operator. This may include negotiating a license to one or more documents, providing billing information, establishing user IDs, and/or the like. The license may apply to an individual, an organization, a business entity, and/or the like. The license may cover a defined period of time, a specific document or group of documents, a method of accessing documents, and/or the like, as is apparent to those skilled in the art. In a specific embodiment, customer information, including license terms, and the like, are stored at the customer information database 114 for later use during the post-stamp process.

At block 210, a customer places an order for one or more documents and the order is received by the system operator. This may comprise receiving an electronic order, via email or the web server, for example. In some embodiments, receiving the order comprises receiving a telephone order via a call center, receiving a mail order in well-known ways, and/or the like. In a specific embodiment, receiving the order at block 210 comprises a customer interacting with an electronic document listing via the web server 108. The customer may be involved in a “session” in which the customer is logged into the web server such that the web server recognizes the customer and the customer's privileges with respect to licensed documents. The “order” may comprise receiving a selection of a document from the customer, wherein the customer has located a document that the customer desires to receive and the customer selects the document by “clicking” on the document, or the like. In this way, the customer may be able to receive a document real time, without having to “check out.” Those skilled in the art, however, will appreciate that a traditional “shopping cart” ordering model may be used.

At block 212, ordered documents are post-stamped. As will be described in greater detail hereinafter, post-stamping comprises populating placeholder objects with specific variables. The specific variables may include copyright information, license information, a customer's identification, session identification information, pre-stamp location information, post-stamp location information, and/or the like. The specific variables may be populated into referenced object placeholders, such that the specific variables are viewable in the rendered document, and/or unreferenced object placeholders, such that the specific variables do not show up in the rendered document but are nevertheless present in the electronic file delivered to the customer. Other possibilities exist, some of which will be described in greater detail below.

At block 214, an electronic file comprising the post-stamped document is delivered to the customer. This may comprise mailing a computer-readable medium to the customer, such as a CD or DVD. In some embodiments, distributing the electronic file comprises loading the file on to the FTP server 116. In a specific embodiment, this comprises allowing the customer to download the file via the Internet and the web server 108. In still other embodiments, delivering the electronic file comprises delivering a limited access printable file as described in more detail in previously-incorporated U.S. patent application Ser. No. 10/977,541 (Attorney Docket No. 040050-000610). Those skilled in the art will appreciate many other possibilities in light of this disclosure.

The two-part document production process speeds “time to customer” by moving time intensive activities “off-line” with respect to the order cycle. Post-stamp activities, including customization, become part of the actual document delivery process. Because of the manner in which placeholders are embedded in pre-stamp and populated in post-stamp, post-stamp takes very little time. In some embodiments, post-stamp adds merely seconds to the typical time for delivering a document from a repository to a customer.

Attention is now directed to FIG. 2B, which illustrates a specific example of a pre-stamp process 204 in greater detail. In pre-stamp, generally two operations are performed: 1) placeholders objects are inserted; and 2) the file is linearized. In this specific example, nine referenced placeholder objects are embedded in an electronic file comprising a page-rendered version of a document and one non-referenced placeholder object is embedded in the file. In this specific embodiment, the file is a PDF file and the placeholder objects are XObjects, which are well-known elements of PDF.

The nine referenced placeholder XObjects may be variables that, although entered only once, appear on a plurality of pages in the final document. Six of the nine referenced placeholder XObjects are in a fixed position on each page relative to the origin of the page and are intended to be populated such that information appears in them in the final document. The three remaining placeholder XObjects serve as “floating zones” such that a single value populated in post-stamp may appear anywhere in the floating zones and may appear in a different location on each page of the final document. A random number generator, or some other scheme, determines the location of the variable XObject on each page. The one non-referenced placeholder object serves as a virtual watermark that may be used to track an electronic file back to a point of origin as will be described in greater detail below.

At block 230, six fixed, referenced XObjects are embedded in the electronic file comprising the page rendered document, three for copyright information and three for license information, corresponding to placeholder objects 304 and 306, respectively, of FIG. 3. The six fixed objects are given absolute coordinates after the page size is determined, and this information becomes a part of the XObject itself. The objects are generated with enough space to store 80 characters in the post-stamped document, but the placeholders could be of any size. The display width of each placeholder XObject is set to zero so they are not visible in a rendering of the document when viewed before post-stamp. The width can be adjusted during post-stamp. In this specific embodiment, the space character (ASCII 32) is stored in the placeholder XObject, although most any character or image may be used.

At block 232, three floating XObjects are embedded, however, the specific locations of these XObjects are not generated; the specific locations are determined during post-stamp. These XObjects are generated with enough space to store 90 characters in the post stamped document. As with the fixed, referenced XObjects, however, the floating placeholders may be any size, since the display width is then set to zero so they are not visible on the document when it is being viewed before post-stamp. The width can be adjusted during post-stamp. Also as with the fixed, referenced placeholder XObjects, the space character (ASCII 32) is stored in the floating placeholder XObject, although most any character or image may be used.

At block 234, an unreferenced XObject is embedded in the electronic file comprising the page rendered document. Because referenced objects possibly could be masked in a hard copy of the document, there is a strong desire to embed watermark information into the electronic file to promote tracking of the electronic file to its origin. Thus, some embodiments include an unreferenced XObject that serves as a non-rendered, inaccessible watermark. The XObject may include metadata and may be encrypted. The metadata could be used to help identify a document's origin. Conversely, the absence of the unreferenced XObject in an otherwise-identifiable electronic file may demonstrate an intent to alter the document. Since most standard page-rendered file editing tools will not copy objects that are not referenced, manipulations of the document using such tools would omit or remove the unreferenced XObject.

The unreferenced XObject, or any other object, may be used to pass information between pre-stamp and post-stamp. Such information may include, for example, a formatted block of data that contains a version number for the block, a version number for the pre-stamp software, a list of XObject names, both referenced and unreferenced, in order, XObject offset locations in the electronic file, and/or the like. Some or all of this information may be encoded into XObject names, as will be described in greater detail below.

In some embodiments, the unreferenced object is populated with additional information in post-stamp. The information added in post-stamp need not be rendered. Such information may include, for example, a session identifier, global identifier (GID), or the like.

At block 235, an intentional error is inserted into the file. The intentional error may be an unreferenced object as discussed above. The error may be customized for each order, thereby identifying a derivative document's specific origin.

At block 236, the file is linearized. Linearization makes online viewing of the downloaded portions of the resultant PDF file much faster, but since it can require rearranging all the objects in the file it can be quite time intensive. This is especially noticeable in larger files, which is where it is most helpful. Thus, files are linearized in pre-stamp. Because of the way the placeholder XObjects are embedded during the pre-stamp process, linearization is not necessary during the post-stamp process. At block 238, the pre-stamped document is stored for download when ordered by a customer.

As the placeholder XObjects are inserted at blocks 230, 232, and 234 above, metadata may be inserted into variable names or global identifiers for the XObjects. In some embodiments, the metadata is spread over a number of variable names and may be obscured by having some characters in each variable name. These metadata characters may be extracted later to determine the metadata.

The metadata may include things like encryption standard, software version, session code, document identifier, and/or the like. Such information may be used, for example, to verify authenticity of a file, to allow traceability to the licensed purchaser, to pass information from pre-production to post production, and/or the like.

In a specific embodiment, the first eight characters of the XObject variable name are generated from a document identifier (global identifier or GiD) by a hash algorithm and the last eight characters are randomly generated. The metadata is spread out over a number of the variable names in the file.

At a later step, when the variable names are actually being inserted into the catalog, the GID may be algorithmically stored into those names using a set of 8 schemes that each have 5 variants. Each of these possible mappings is generated by using a random number generator. Each of the 16 characters of the GID (or some other metadata) are mapped into the last 8 characters of the various XObject names. A predetermined variable name identifies the scheme and variant stored in fixed places so a program wishing to extract the GID from the names will know which scheme and variant to use. Since this sequence is only known to the originator of the document and since there are so many variants, it would be very difficult for anyone to discover that the information is stored in this manner, even if they knew the GID of the document, data which is not normally known to the end user. The embedding of the GID as metadata in the variable names is a way of proving that a document originated from a particular source in one embodiment.

Having described the pre-stamp process, attention is directed to FIG. 2C, which illustrates the post-stamp process 212 in greater detail. As with the previously-described method embodiments, other post-stamp method embodiments may include more, fewer, or different steps than those illustrated and described herein. Further, the blocks illustrated and described here may be traversed in different orders, as is apparent to those skilled in the art in light of this disclosure.

Post-stamp generally involves two operations: 1) placeholders are populated with specific values; and 2) the width of the specific value is determined and substituted into the file so the text or image is properly displayed in a rendering of the file. Placeholder offset locations may be determined by inspection, from the embedded XObjects themselves, and/or the like. Normal file operations may be used to seek to the offsets and substitute the specific values for the placeholder characters used in pre-stamp. Where the resulting file is encrypted, the placeholders may be filled with encrypted information.

With respect to PDF files, the RC4 encryption algorithm used by Adobe makes bifurcated production possible. When XObjects are embedded in pre-stamp, the space character (ASCII 32) serves as a placeholder for the information to be populated later. For each character, the exclusive OR (XOR) operation may be used to mask out just the encryption bits. The replacement character then may be populated by using the XOR function with the extracted encryption bits with the effect of encrypting that character. Thus, each specific value may be processed character by character for each XObject.

Part of the post-stamp process involves determining width of the specific value in pixels and adjusting the width of the blanking box to match the width of the output stream. This is done primarily for aesthetic reasons to make the rendered document look “professional.”

Continuing the discussion of this specific embodiment of a post-stamp process, when a document is ordered, a copy of the pre-stamped file comprising the document is made at block 250. The locations of the XObject placeholders within the electronic file are then determined at block 252. In some embodiments, this comprises locating the unreferenced XObject and extracting the file offset location of each XObject from the unreferenced XObject. In some embodiments, the file offset locations may be encoded in the XObject names.

At block 254, copyright information relating to the document is obtained. Such information may be stored along with available documents at the database 106 or other suitable location. Copyright information may include, for example, the name of the copyright holder, the year of the copyright, and the rights that the copyright holder reserves. In some embodiments, it is advantageous to have the copyright information stored external to the pre-stamped document to make updates easier. Otherwise, every stored document would need to be re-post-stamped to simply update the copyright, for example. The copyright information is populated at block 256.

License information is obtained at block 258 and populated at block 260. Obtaining license information may comprise downloading specific customer license information from the database 114, for example.

At block 262, information for the variable field XObject is collected. A number of different items may be included in the variable field XObject, some of which may come from the unreferenced XObject, the web server, any of the XObject names, license information, and/or the like. For example, the variable field XObject may include a session ID that identifies a customer via data recorded at the web server during the “session” in which a customer logged into the web server ordered the document. As a result of the way the specific value for the variable field XObject appears in a rendering of the document, direct reproductions of the document will reveal the specific value, thereby revealing the document origin.

In some embodiments, the specific value of the variable field XObject is an image that has information encoded therein. The image may be a bar code or the like. In some embodiments, the “|” and “ ” (vertical bar and space) characters are used to encode this information. In other embodiments, the “′” and “,” (grave accent and comma) are used to encode the pre-stamp site, post-stamp site, and session ID as a 64 bit quantity. The code is prefixed with two “-” (dash) characters, a “-” (dash) character separates the components, and three “-” characters note the end of the stamp. In the instance that the resulting code is too long, the code may be truncated and the trailing dashes replaced with ‘+’ (plus) characters. Many other embodiment are possible and apparent to those skilled in the art in light of this disclosure. The variable field XObject is populated at block 264.

At block 266, information for the unreferenced XObject is collected. Such information may include any of the information mentioned previously herein. The information is populated at block 268.

It should be understood that the XObjects may be populated sequentially with respect to their offset location in the file. Thus, the post-stamp method 212 could progress by first collecting all the XObject information, then populating the XObjects during a pass through the electronic file.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. For example, those skilled in the art know how to arrange computers into a network and enable communication among the computers. Accordingly, the above description should not be taken as limiting the scope of the invention, which is defined in the following claims.

1. A method of delivering a document, comprising:
providing an electronic file comprising a page rendered version of the document;
embedding at least one placeholder object into the electronic file during a first document preparation process;
thereafter, populating a specific value into the at least one placeholder object during a second document preparation process; and
transmitting an electronic file comprising the document to a requester.

2. The method of claim 1, wherein providing an electronic file comprising a page rendered version of the document comprises providing an electronic file in Portable Document Format.

3. The method of claim 1, wherein providing an electronic file comprising a page rendered version of the document comprises scanning a hard copy of the document to create the page rendered version of the document.

4. The method of claim 1, wherein providing an electronic file comprising a page rendered version of the document comprises converting an electronic file comprising a non-page rendered version of the document to the page rendered version of the document.

5. The method of claim 1, wherein embedding at least one placeholder object into the electronic file comprises embedding an unreferenced placeholder object into the electronic file.

6. The method of claim 1, wherein embedding at least one placeholder object into the electronic file comprises embedding a referenced placeholder object into the file.

7. The method of claim 6, wherein embedding a referenced placeholder object into the file comprises embedding a fixed location placeholder object into the file.

8. The method of claim 6, wherein embedding a referenced placeholder object into the file comprises embedding a variable location placeholder object into the file.

9. The method of claim 1, wherein populating a specific value into the at least one placeholder object comprises populating copyright information into a fixed location placeholder object.

10. The method of claim 1, wherein populating a specific value into the at least one placeholder object comprises populating license information into a fixed location placeholder object.

11. The method of claim 1, wherein populating a specific value into the at least one placeholder object comprises populating an encoded image into a variable location placeholder object.

12. The method of claim 1, wherein transmitting an electronic file comprising the document to the requestor comprises emailing the document.

13. The method of claim 1, wherein transmitting an electronic file comprising the document to the requester comprises mailing a computer-readable medium comprising the document.

14. The method of claim 1, wherein transmitting an electronic file comprising the document to the requestor comprises storing the document on a server for downloading by the requester.

15. A document delivery system, comprising:
a storage arrangement;
a processor; and
a computer-readable medium having stored thereon computer-executable instructions that program the processor to:
receive an electronic file comprising a page rendered version of a document;
embed at least one placeholder object into the electronic file during a first document preparation process;
store the electronic file comprising the embedded placeholder object at the storage arrangement for further processing;
populate a specific value into the at least one placeholder object during a second document preparation process; and
transmit the electronic file comprising the document to a requestor.

16. The method of claim 15, wherein in programming the processor to receive an electronic file comprising a page rendered version of a document, the computer-executable instructions program the processor to receive an electronic file in Portable Document Format.

17. The method of claim 15, wherein in programming the processor to embed at least one placeholder object into the electronic file, the computer-executable instructions program the processor to embed a variable location placeholder object into the file.

18. The method of claim 17, wherein the object comprises an XObject associated with Portable Document Format.

19. A document delivery system, comprising:
means for storing electronic files;
means for embedding a placeholder object into an electronic file comprising a page rendered version of a document;
means for populating a specific value into the at least one placeholder object; and
means for transmitting the electronic file comprising the document to a requestor.

20. A computer-readable medium having stored thereon:
instructions for programming a processor to receive an electronic file comprising a page rendered version of a document;
instructions for programming the processor to embed at least one placeholder object into the electronic file;
instructions for programming the processor to store the electronic file comprising the embedded placeholder object for further processing;
instructions for programming the processor to populate a specific value into the at least one placeholder object; and
instructions for programming the processor to transmit the electronic file comprising the document to a requestor.

21. The method of claim 20, wherein the instructions for programming a processor to receive an electronic file comprising a page rendered version of a document comprise instructions for programming the processor to receive the electronic file in Portable Document Format.
